(19) United States
(12) Patent Application Publication
(10) Pub. No.: US 2015/0364289 A1
(43) Pub. Date: Dec. 17, 2015

(54) RADIATION GENERATING APPARATUS

(71) Applicant: Metal Industries Research & Development Centre, Kaohsiung (TW)

(72) Inventors: Yen-Chun Chen, Kaohsiung City (TW); Wei-Hung Shih, Kaohsiung City (TW); Yi-San Chang, Tainan City (TW); Tsung-Chih Yu, Tainan City (TW); Wen-Hsin Hsieh, Taipei City (TW); Ming-Hui Cheng, Kaohsiung City (TW)

(21) Appl. No.: 14/616,752

(22) Filed: Feb. 9, 2015

(30) Foreign Application Priority Data
Jun. 11, 2014 (TW) 103120208

(51) Int. Cl. H01J 35/12

(52) U.S. Cl. CPC H01J 35/12; H01J 2235/1204; H01J 2235/1262; H01J 2235/186

(57) ABSTRACT

A radiation generating apparatus includes a target base, a target, an electronic beam generating device, a tube, a tank, and a porous structure. The target is disposed on the target base. The electronic beam generating device is adapted to generate an electronic beam, and the electronic beam is emitted to the target to generate a radiation. The tube accommodates the target and the electronic beam generating device. The tank is connected to the target base and is accommodated by the tube. The porous structure is disposed in the tank and contacts the target base. A cooling fluid flows through the porous structure to dissipate the heat of the porous structure.

### CROSS-REFERENCE TO RELATED APPLICATION

This application claims the priority benefit of Taiwan application serial no. 103120208, filed on Jun. 11, 2014. The entirety of the above-mentioned patent application is hereby incorporated by reference herein and made a part of this specification.

### BACKGROUND OF THE INVENTION

1. Field of the Invention

The invention relates to a radiation generating apparatus. Particularly, the invention relates to a radiation generating apparatus capable of using an electronic beam to irradiate a target to generate radiation.

2. Description of Related Art

An X-ray tube is an image device capable generating X-rays, which can be applied in fields of industrial testing, medical diagnosis or medical treatment. Generally, an X-ray tube includes an electronic beam generating device and a target, where the electronic beam generating device can be composed of a high-voltage power supplier and a tungsten filament. When the high-voltage power supplier supplies enough current to the tungsten filament, the tungsten filament generates an electronic beam, and the electronic beam is emitted to the target to generate the X-ray.

In the aforementioned operation process, most of the energy of the electronic beam emitted to the target is converted into heat, which increases the temperature of the target. Thus, under a high-power operation, the high-energy electronic beams that continuously strike the X-ray target may overheat and damage the X-ray target, decreasing a service life of the X-ray target. Thus, how to effectively perform heat dissipation towards the target is an important research topic in this particular field.

### SUMMARY OF THE INVENTION

The invention is directed to a radiation generating apparatus, which can avoid overheating of a target.

The invention provides a radiation generating apparatus including a target base, a target, an electronic beam generating device, a tube, a tank, and a porous structure. The target is disposed on the target base. The electronic beam generating device is adapted to generate an electronic beam, and the electronic beam is emitted to the target to generate a radiation. The tube accommodates the target and the electronic beam generating device. The tank is connected to the target base and accommodates the tube. The porous structure is disposed in the tank and contacts the target base. A cooling fluid flows through the porous structure to dissipate the heat of the porous structure.

In an embodiment of the invention, the tank includes a thermal conductive structure therein. The thermal conductive structure connects to the target base and contacts the porous structure.

In an embodiment of the invention, the tank includes at least one cooling fluid inlet and at least one cooling fluid outlet. The cooling fluid flows into the tank through the cooling fluid inlet, and flows out of the tank through the cooling fluid outlet.

In an embodiment of the invention, the radiation generating apparatus further includes a temperature sensing element. The temperature sensing element is disposed at the cooling fluid inlet, for sensing a temperature of the cooling fluid.

In an embodiment of the invention, the radiation generating apparatus further includes a temperature sensing element. The temperature sensing element is disposed at the cooling fluid outlet, for sensing a temperature of the cooling fluid.

In an embodiment of the invention, the radiation generating apparatus further includes a temperature sensing element. The temperature sensing element is disposed on the target base, for sensing a temperature of the target base.

In an embodiment of the invention, the target base includes a first surface and a second surface opposite to each other. The first surface faces the electronic beam generating device, the target is disposed on the first surface, and the temperature sensing element is disposed on the second surface.

In an embodiment of the invention, the tank includes a partition structure therein. The partition structure divides the tank into an inner region and an outer region. The outer region surrounds the inner region. The porous structure is located in the inner region. The partition structure includes at least one opening. The cooling fluid flows from the inner region to the outer region through the opening.

In an embodiment of the invention, the target is an X-ray target, and the radiation is an X-ray.

In an embodiment of the invention, the radiation penetrates through the target base to be emitted out.

Based on the above, the radiation generating apparatus includes a porous structure surrounding the tube and contacting the tank, and the cooling fluid flows through the porous structure. The porous structure, by way of a plurality of holes of the porous structure, has a large contact area with the cooling fluid. This way, the heat transmitted from the target base to the porous structure can quickly depart from the porous structure through the cooling fluid. Thus, the heat dissipation of the target base is effectively improved, so as to prevent the target from overheating, further lengthening the service life of the target.

To make the above features and advantages of the invention more comprehensible, several embodiments accompanied with drawings are described in detail as follows.

### BRIEF DESCRIPTION OF THE DRAWINGS

FIG. 1 is a schematic diagram of a radiation generating apparatus according to an embodiment of the invention.

FIG. 2 is a partially enlarged schematic diagram of a radiation generating apparatus according to another embodiment of the invention.

### DESCRIPTION OF EMBODIMENTS

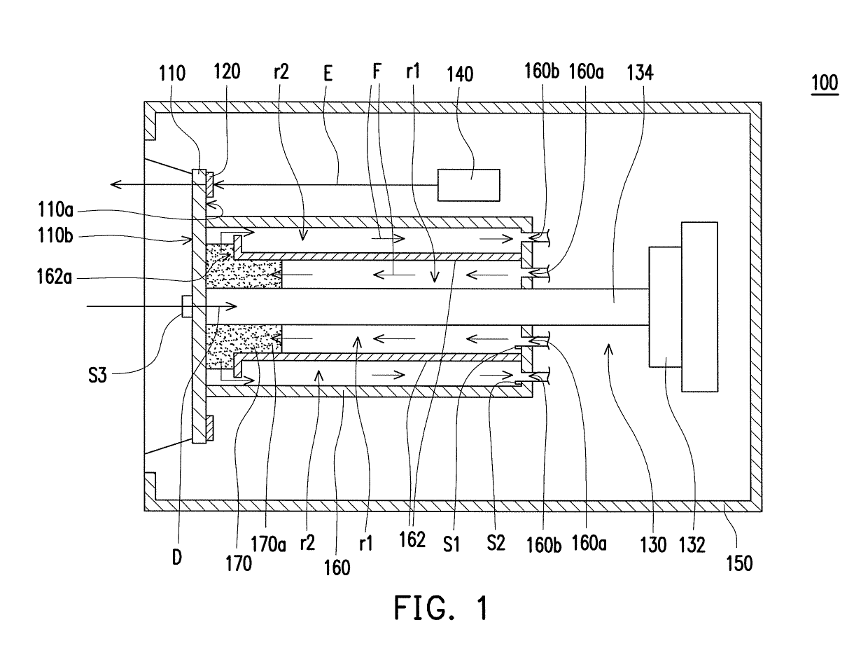

FIG. 1 is a schematic diagram of a radiation generating apparatus according to an embodiment of the invention. Referring to FIG. 1, the radiation generating apparatus 100 of the embodiment is, for example, a transmission type X-ray tube applied in fields of industrial testing, medical diagnosis or medical treatment. The radiation generating apparatus 100 includes a target base 110, a target 120, a holding assembly 130, an electronic beam generating device 140, a tube 150, a tank 160, and a porous structure 170. The tube 150 is, for example, a vacuum tube suitable for the X-ray tube, and the holding assembly 130 is disposed in the tube 150 and holds the target base 110. The target 120 is, for example, an X-ray target, and is disposed on the target base 110. The electronic beam generating device 140 is adapted to generate an electronic beam E. The electronic beam E is emitted to the target 120 along an axial direction D of the holding assembly 130, to generate a radiation R such as an X-ray. The radiation R penetrates through the target base 110 to be emitted out.

In detail, the tube 150 accommodates the target base 110, the target 120, the holding assembly 130, and the electronic beam generating device 140. The tank 160 connects to the target base 110 and is accommodated by the tube 150. The porous structure 170 is disposed in the tank 160, and is surrounded by the tube 150 and contacted with the target base 110. The heat of the target base 110 is transmitted to the porous structure 170. A cooling fluid F is adapted to flow through the porous structure 170 so as to perform heat dissipation towards the porous structure 170. In the embodiment, the porous structure 170 includes a plurality of holes 170a. A material of the porous structure 170 is, for example, a metal material with high thermal conductivity or other suitable materials. The invention is not limited thereto. In addition, the cooling fluid F of the embodiment is, for example, water, cooling oil, environmental refrigerant, liquid carbon dioxide, liquid oxygen, liquid nitrogen, or other suitable cooling fluids. The invention is not limited thereto.

Based on the above configuration, the radiation generating apparatus 100 includes the porous structure 170 surrounded by the tube 150 and contacting the target base 110. The cooling fluid F flows through the porous structure 170. The porous structure 170, by way of the plurality of holes 170a of the porous structure 170, has a large contact area with the cooling fluid F. This way, the heat transmitted from the target base 110 to the porous structure 170 can quickly depart from the porous structure 170 through the cooling fluid F. Thus, the heat dissipation of the target base 110 is effectively improved, so as to prevent the target 120 from overheating, further lengthening the service life of the target 120.

In the embodiment, the tank 160 includes at least one cooling fluid inlet 160a (two are shown in the figure provided) and at least one cooling fluid outlet 160b (two are shown in the figure provided). The cooling fluid F is suitable to flow into the tank 160 through the cooling fluid inlet 160a. This way, the heat from the porous structure 170 can be transmitted to the cooling fluid F. After the heat from the porous structure 170 is transmitted to the cooling fluid F, the cooling fluid F flows out of the tank 160 through the cooling fluid outlet 160b. The cooling fluid inlet 160a and the cooling fluid outlet 160b are, for example, connected to a pump and a heat exchanger through piping. This way, the pump drives the cooling fluid F to circulate, and the heat exchanger performs heat exchanging towards the cooling fluid F. The method of performance of the pump and the heat exchanger are known to one of ordinary skill in the art, and is not described herein.

Please refer to FIG. 1. In the embodiment, the radiation generating apparatus 100 includes a temperature sensing element S1 and a temperature sensing element S2. The temperature sensing element S1 and the temperature sensing element S2 are respectively disposed at the cooling fluid inlet 160a and the cooling fluid outlet 160b. This way, the temperature of the cooling fluid F at the cooling fluid inlet 160a and the cooling fluid outlet 160b can be sensed, so as to determine if the temperatures are within a predetermined range. Thus, it can be determined if the cooling fluid F can adequately perform heat dissipation towards the target base 110. In addition, the radiation generating apparatus 100 further includes a temperature sensing element S3. The temperature sensing element S3 is disposed on the target base 110, so as to sense the temperature of the target base 110. This way, it can be determined if the target base 110 has overheated.

In the embodiment, the target base 110 includes a first surface 110a and a second surface 110b. The first surface 110a faces the electronic beam generating device 140. The target 120 is disposed on the first surface 110a of the target base 110, so as to be struck by an electronic beam E generated by the electronic beam generating device 140. The temperature sensing element S3 is then disposed on the second surface 110b of the target base 110, and is not struck by the electronic beam E generated by the electronic beam generating device 140.

In other embodiments, only one or two of the temperature sensing element S1, the temperature sensing element S2, and the temperature sensing element S3 may be disposed, or no temperature sensing elements are disposed. The invention is not limited thereto.

As seen in FIG. 1, in the embodiment, the target 120, the holding assembly 130, and the electronic beam generating device 140 are all disposed on a same side of the target base 110 (shown as the right side of the target base 110), and are not respectively disposed on two opposite sides of the target base 110. This way, the volume of the radiation generating apparatus 100 can be effectively reduced, so as to not take up space, which satisfies user needs.

In the embodiment, the tank 160 includes a partition structure 162 therein. The partition structure 162 divides the tank 160 into an inner region r1 and an outer region r2. The outer region r2 surrounds the inner region r1. The porous structure 170 is located in the inner region r1. The partition structure 162 includes at least one opening 162a. A cooling fluid F flows from the inner region r1 to the outer region r2 to the opening 162a. Thus, the flow path of the cooling fluid F is increased, so that the cooling fluid F can adequately perform heat exchanging with the tank 160 and the partition structure 162. This way, the heat of the target base 110 can be quickly transmitted to the cooling fluid F through the tank 160 and the partition structure 162, further improving heat dissipation efficiency.

In the embodiment, the opening 162a is, for example, a single circular opening. However, the invention is not limited thereto. In other embodiments, the opening 162a can be a plurality of discontinuous openings. In addition, in the embodiment, the porous structure 170 is shown as only filling a part of the space in the inner region r1. However, the invention is not limited thereto. In other embodiments, the porous structure 170 can fill the entire space of the inner region r1.

In the embodiment, the holding assembly 130 includes a thermal conductive structure 134. The thermal conductive structure 134 is, for example, a rotating shaft. The thermal conductive structure 134 is connected to the target base 110, and the target 120 is a ring shape that surrounds the thermal conductive structure 134. The holding assembly 130 further includes a drive unit 132. The drive unit 132 is adapted to drive the thermal conductive structure 134 and the target base 110 to rotate about the axial direction D. This way, the regions of the target 120 that are struck by the electronic beam E are continuously changed. As a result, the length of time of different regions of the target 120 that are not struck by the electronic beam E increases, which improves heat dissipation efficiency. The thermal conductive structure 134 of the embodiment contacts the porous structure 170. This way, the heat of the target base 110 can be transmitted to the porous structure 170 through the thermal conductive structure 134, to further improve the heat dissipation efficiency of the target base 110.

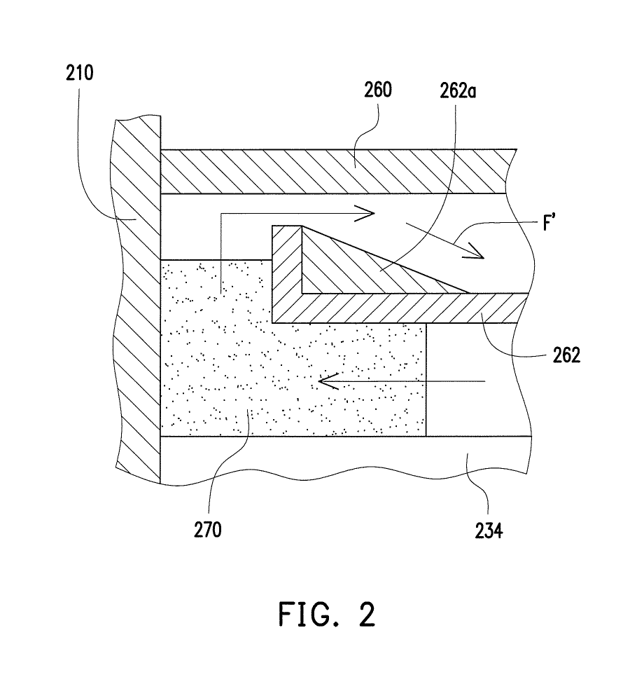

FIG. 2 is a partially enlarged schematic diagram of a radiation generating apparatus according to another embodiment of the invention. In the embodiment of FIG. 2, the configurations and functions of the target base 210, the thermal conductive structure 234, the tank 260, the partition structure 262, and the porous structure 270 are similar to the configurations and functions of the target base 110, the thermal conductive structure 134, the tank 160, the partition structure 162, and the porous structure 170 of FIG. 1. Similar descriptions will not be repeated herein. The difference between the embodiment of FIG. 2 and the embodiment of FIG. 1 is the partition structure 262 further includes a diversion structure 262a. The diversion structure 262a guides the cooling fluid F′ at a turning portion of the flow path. This way, the cooling fluid F′ can more smoothly flow so as to further improve heat dissipation efficiency. In addition, a material of the diversion structure 262a is, for example, a high thermal conductivity material, so that the cooling fluid F′ can perform heat exchanging with the diversion structure 262a. Thus, the heat of the target base 210 can be quickly transmitted to the cooling fluid F′ through the tank 260, the partition structure 262, and the diversion structure 262a, further improving heat dissipation efficiency.

To sum up, the radiation generating apparatus includes a porous structure surrounding the tube and contacting the tank, and the cooling fluid flows through the porous structure. The porous structure, by way of a plurality of holes of the porous structure, has a large contact area with the cooling fluid. This way, the heat transmitted from the target base to the porous structure can quickly depart from the porous structure through the cooling fluid. Thus, the heat dissipation of the target base is effectively improved, so as to prevent the target from overheating, further lengthening the service life of the target. In addition, the porous structure contacts the rotating shaft (i.e. the aforementioned thermal conductive structure) of the target base. Thus, the heat of the target base is transmitted to the porous structure through the rotating shaft, so as to further improve the heat dissipation efficiency of the target base. Furthermore, temperature sensing elements can be disposed at the cooling fluid inlet, the cooling fluid outlet, and the target base. By utilizing the temperature sensing elements, it can be determined if the cooling fluid can adequately perform heat dissipation towards the target base, and if the target base has overheated. In addition, a partition structure can be disposed in the tank so as to increase a flow path of the cooling fluid. This way, the cooling fluid can adequately perform heat exchanging between the tank and the partition structure, further improving heat dissipation efficiency.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A radiation generating apparatus, comprising:
a target base;
a target, disposed on the target base;
an electronic beam generating device, adapted to generate an electronic beam, wherein the electronic beam is emitted to the target to generate a radiation;
a tube, accommodating the target and the electronic beam generating device;
a tank, connected to the target base and being accommodated by the tube; and
a porous structure, disposed in the tank and contacting the target base;
wherein a cooling fluid flows through the porous structure, so as to dissipate a heat of the porous structure.

2. The radiation generating apparatus as claimed in claim 1, wherein the tank includes a thermal conductive structure therein, the thermal conductive structure connects to the target base and contacts the porous structure.

3. The radiation generating apparatus as claimed in claim 1, wherein the tank includes at least one cooling fluid inlet and at least one cooling fluid outlet, wherein the cooling fluid flows into the tank through the cooling fluid inlet, and flows out of the tank through the cooling fluid outlet.

4. The radiation generating apparatus as claimed in claim 3, further comprising a temperature sensing element, wherein the temperature sensing element is disposed at the cooling fluid inlet, for sensing a temperature of the cooling fluid.

5. The radiation generating apparatus as claimed in claim 3, further comprising a temperature sensing element, wherein the temperature sensing element is disposed at the cooling fluid outlet, for sensing a temperature of the cooling fluid.

6. The radiation generating apparatus as claimed in claim 1, further comprising a temperature sensing element, wherein the temperature sensing element is disposed on the target base, for sensing a temperature of the target base.

7. The radiation generating apparatus as claimed in claim 6, wherein the target base includes a first surface and a second surface opposite to each other, wherein the first surface faces the electronic beam generating device, the target is disposed on the first surface, and the temperature sensing element is disposed on the second surface.

8. The radiation generating apparatus as claimed in claim 1, wherein the tank includes a partition structure therein, the partition structure divides the tank into an inner region and an outer region, the outer region surrounds the inner region, the porous structure is located in the inner region, the partition structure includes at least one opening, and the cooling fluid flows from the inner region to the outer region through the opening.

9. The radiation generating apparatus as claimed in claim 1, wherein the target is an X-ray target, and the radiation is an X-ray.

10. The radiation generating apparatus as claimed in claim 1, wherein the radiation penetrates through the target base to be emitted out.
